(19) United States
(12) Patent Application Publication
(10) Pub. No.: US 2016/0344632 A1
(43) Pub. Date: Nov. 24, 2016

(54) TRANSMISSION DEVICE, TRANSMISSION METHOD, AND PROGRAM RECORDING MEDIUM

(71) Applicant: NEC Corporation, Tokyo (JP)

(72) Inventor: Hiroshi Yoshida, Tokyo (JP)

(73) Assignee: NEC Corporation, Tokyo (JP)

(21) Appl. No.: 15/112,224

(22) PCT Filed: Jan. 15, 2015
(86) PCT No.: PCT/JP2015/000161

§ 371 Date: Jul. 18, 2016

(30) Foreign Application Priority Data
Jan. 20, 2014 (JP) 2014-007780

(51) Int. Cl. H04L 12/801; H04L 12/26; H04L 29/06; H04L 12/815

(52) U.S. Cl. CPC H04L 47/12; H04L 47/225; H04L 43/0888; H04L 65/80

(57) ABSTRACT

In order to transmit data with a short delay time and high quality, a transmission device according to the present invention includes: a transmission rate determination means which calculates an optimum transmission rate by estimating a throughput generated when the data is transmitted to the reception device at an initial transmission rate set as an unknown function, calculating a transmission completion time, which is taken until transmission of the data to the reception device is completed, by use of a data size of the data and the initial transmission rate, calculating a loss ratio of the data in a communication circuit network on the basis of the throughput, the data size, and the initial transmission rate, and solving an optimization problem of minimizing a cost function including the transmission completion time and the loss ratio; and a data transmission means which transmits the data at the optimum transmission rate.

### TECHNICAL FIELD

The present invention relates to a transmission device, a transmission method and a program recording medium. Especially, the present invention relates to a transmission device and a transmission method for transmitting a large volume of data such as the frame data, and relates to a program recording medium which records a transmission program for transmitting a large volume of data such as the frame data.

### BACKGROUND ART

In the case of carrying out screen-display transmission in the thin-client system or image transmission in the video conference system through a best effort type IP (Internet Protocol) network, it is requested to make a delay time, which is taken for transmission, short. Accordingly, when transmitting a large volume of data through the best effort type IP network such as the Internet or the mobile network, UDP (User Datagram Protocol) is often used as the protocol of the transport layer. Here, as the best effort type IP network, the Internet, the mobile network or the like is exemplified.

However, when transmitting data, whose size is large, such as screen-display data (hereinafter, referred to as frame data) by use of UDP, there is a problem that congestion is caused in a network, and consequently data loss (packet loss) is caused.

An art which solves the above-mentioned problem is disclosed by PTL (patent literature) 1.

PTL 1 discloses an art (hereinafter, referred to as a rate control art) that, by adjusting a bit rate of the frame data (frame data size per unit regeneration time), the packet loss due to the network congestion, which is caused at a time when transmitting the frame data, is avoided. The rate control art is an art for adjusting an average size of the frame data which are generated per a unit time.

Meanwhile, the actual frame data are generated according to a frame rate of the frame data (number of screen-displays which are generated per the unit time) Therefore, as shown in FIG. 10, according to the rate control, it is possible to control the average transmission rate at a long time interval, but an instantaneous transmission rate at a short time interval, that is, per the frame becomes large. As a result, there are some cases that the rate control causes instantaneous congestion to the network. Especially, in the case of generating a screen display which includes a significant change in motion, or generating an intra-frame, a size of the frame data to be transmitted becomes large, and also the instantaneous transmission rate becomes large. Here, the intra frame means frame data which are coded without using the inter-frame prediction method based on information of a preceding frame and a following frame. In general, in comparison with frame data which are coded with the inter-frame prediction method based on information of the preceding frame and the following frame, the intra-frame has a large data size.

PTL 2 discloses an art which solves the problem of PTL 1 that the transmission rate increases instantaneously.

PTL 2 discloses an art related to packet shaping which monitors an input and an output of a buffer memory of a network, and avoids the instantaneous network congestion by setting an upper limit to the transmission rate so that the buffer memory may not overflow. FIG. 11 shows an example of carrying out the packet shaping to the example of the transmission rate shown in FIG. 10. According to the example shown in FIG. 11, since data are transmitted so that the transmission rate may not exceed the set upper limit, it takes much time to complete transmission of a frame which has a large size.

### CITATION LIST

### Patent Literature

[PTL 1] Japanese Patent Application Laid-Open Publication No. 2003-244695

[PTL 2] Japanese Patent Application Laid-Open Publication No. 2003-46555

### SUMMARY OF INVENTION

### Technical Problem

The above-mentioned packet shaping of PTL 2 has the following problems.

A first problem is that the packet shaping is not applicable to a system, which is realized by an application of end host, such as the thin client system or the video conference system. The reason is that it is necessary to monitor an amount of buffered data of the network.

A second problem is that, in the case that the upper limit is set without monitoring the buffer memory, a value of the set upper limit causes severe influence to the screen-display transmission system. That is, in the case that the value of the upper limit is too large, it is impossible to avoid the congestion. On the other hand, in the case that the value of the upper limit is too small, it takes much time to complete transmission of the frame data.

An object of the present invention is to provide a transmission device, a transmission method and a transmission program which carry out bit rate control able to enhance both of responsiveness and media quality.

### Solution to Problem

A transmission device according to the present invention, which is a transmission device for transmitting data to a reception device through a communication circuit network, the transmission device comprising: a transmission rate determination means that calculates an optimum transmission rate by estimating a throughput generated when the data is transmitted to the reception device at an initial transmission rate set as an unknown function, calculates a transmission completion time, which is taken until transmission of the data to the reception device is completed, by use of a data size of the data and the initial transmission rate, and calculates a loss ratio of the data in the communication circuit network on the basis of the throughput, the data size, and the initial transmission rate, and solving an optimization problem of minimizing a cost function including the transmission completion time and the loss ratio; and a data transmission means that transmits the data at the optimum transmission rate.

A transmission method according to the present invention, which is a transmission method for transmitting data to a reception device through a communication circuit network, the transmission method comprising: calculating an optimum transmission rate by estimating a throughput which is generated when the data is transmitted to the reception device at an initial transmission rate set as an unknown function, calculating a transmission completion time, which is taken until transmission of the data to the reception device is completed, by use of a data size of the data and the initial transmission rate, calculating a loss ratio of the data in the communication circuit network on the basis of the throughput, the data size, and the initial transmission rate, and solving an optimization problem of minimizing a cost function including the transmission completion time and the loss ratio; and transmitting the data at the optimum transmission rate.

A program according to the present invention, which is a transmission program that transmits data to a reception device through a communication circuit network, the transmission program causing a computer to execute: a process for estimating a throughput which is generated when the data is transmitted to the reception device at an initial transmission rate set as an unknown function; a process for calculating a transmission completion time, which is taken until transmission of the data to the reception device is completed, by use of a data size of the data and the initial transmission rate; a process for calculating a loss ratio of the data in the communication circuit network on the basis of the throughput, the data size, and the initial transmission rate; a process for calculating an optimum transmission rate by solving an optimization problem of minimizing a cost function including the transmission completion time and the loss ratio; and a process for transmitting the data at the optimum transmission rate.

### Advantageous Effects of Invention

According to the present invention, it is possible to provide a transmission device, a transmission method and a transmission program which carry out bit rate control able to enhance both of responsiveness and media quality by realizing data transmission with a short delay time and a small loss.

### BRIEF DESCRIPTION OF DRAWINGS

FIG. 1 is a block diagram showing a schematic configuration of a transmission and reception system which includes a transmission device according to an exemplary embodiment of the present invention.

FIG. 2 is a block diagram showing a functional configuration of the transmission device according to the exemplary embodiment of the present invention.

FIG. 3 is a block diagram showing a functional configuration of a transmission rate determination means according to the exemplary embodiment of the present invention.

FIG. 4 is a block diagram showing a functional configuration of a transmission rate determination means according to a modification of the exemplary embodiment of the present invention.

FIG. 5 is a conceptual diagram showing an internal function of the transmission device according to the exemplary embodiment of the present invention.

FIG. 6 is a flowchart for explaining an operation of the transmission rate determination means according to the exemplary embodiment of the present invention.

FIG. 7 is a conceptual diagram showing a dynamics model which is used for throughput estimation carried out by the transmission device according to the exemplary embodiment of the present invention.

FIG. 8 is a graph showing an example of a transmission completion time which is calculated by a transmission completion time calculation means of the transmission device according to the exemplary embodiment of the present invention, and an example of a loss ratio which is calculated by a loss ratio calculation means of the transmission device.

FIG. 9 is a graph showing an example of a value of a cost function and an example of a differential value of the cost function in the transmission device according to the exemplary embodiment of the present invention.

FIG. 10 is a conceptual diagram for explaining an instantaneous transmission rate which is generated at a time when frame data is generated.

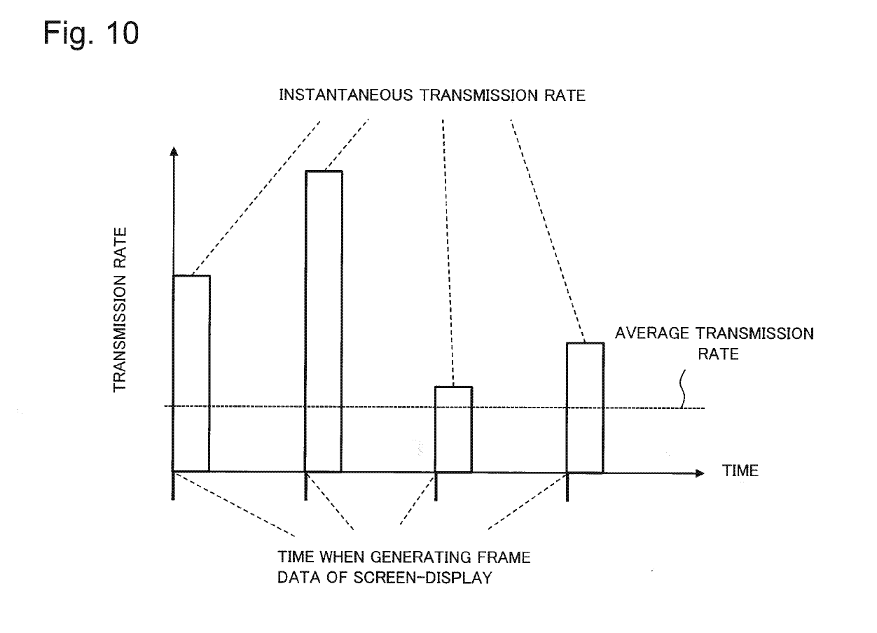

FIG. 11 is a conceptual diagram for explaining the transmission rate which is generated when carrying out packet shaping.

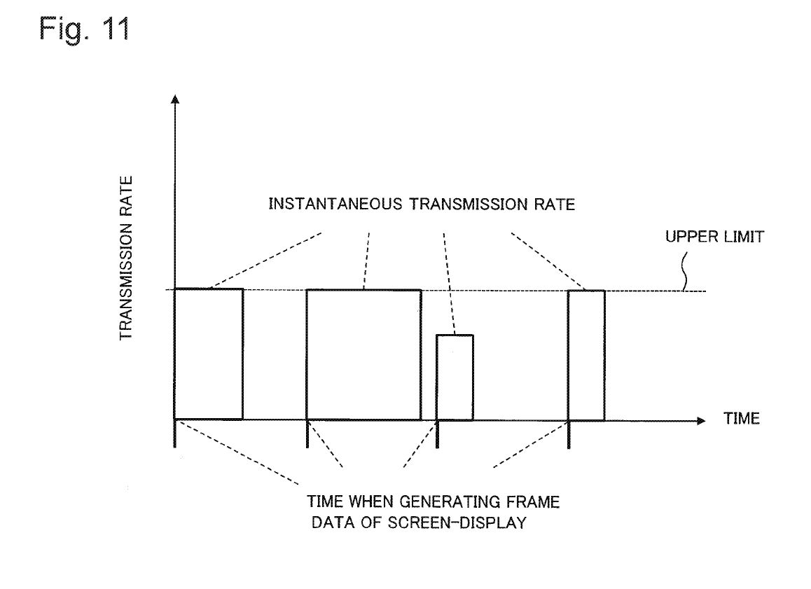

### DESCRIPTION OF EMBODIMENTS

Hereinafter, an exemplary embodiment for carrying out the present invention will be explained with reference to drawings. While the exemplary embodiment, which will be mentioned later, has technically preferable limitation for carrying out the present invention, the scope of invention is not limited to the following mention.

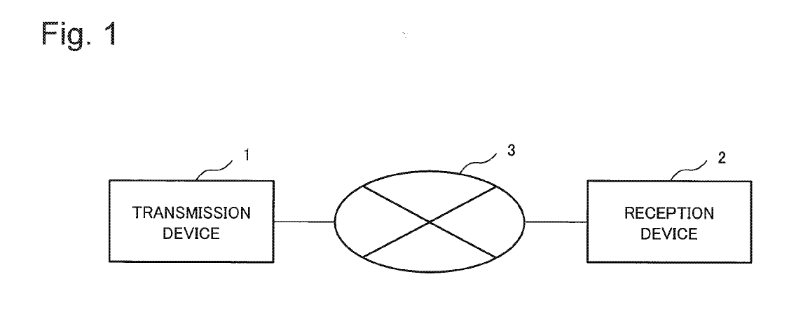

As shown in FIG. 1, a transmission and reception system, which includes a transmission device according to the exemplary embodiment, includes a transmission device 1 and a reception device 2. The transmission device 1 and the reception device 2 are connected each other through a communication circuit network 3 (also referred to as a network), which composes an IP (Internet Protocol) network, so as to be able to communicate. Here, a configuration of the transmission and reception system according to the exemplary embodiment may include the communication circuit network 3.

While an example that frame data are used as data will be explained in the following, technique of the present exemplary embodiment is applicable to not only the frame data but also a whole of general data. Especially, the technique of the present exemplary embodiment is suitable to data, to which a transmission rate has to be set instantaneously at a time when generating the data, such as the frame data.

(Transmission Device)

The transmission device 1 according to the present exemplary embodiment is a transmission device which transmits data to the reception device through the communication circuit network 3.

The transmission device 1 sets an initial transmission rate of the generated data, and estimates a throughput which is generated when transmitting the data to the reception device at the initial transmission rate. Moreover, the transmission device 1 calculates a transmission completion time, which is taken until transmission of the data to the reception device is completed, by use of a data size of the data and the initial transmission rate. Then, the transmission device 1 calculates a loss ratio of the data in the communication circuit network 3 on the basis of the estimated value of the throughput, the data size and the initial transmission rate. Furthermore, the transmission device 1 calculates an optimum transmission rate by solving an optimization problem of minimizing a cost function including the transmission completion time and the loss ratio, and transmits the data at the optimum transmission rate which is calculated.

The transmission device 1 is realized as an information processing device which has a hardware configuration including a central processing device (CPU: Central Processing Unit), a main storage device such as a memory or the like, an auxiliary storage device such as a hard disc or the like, a communication device, and the like that are not shown in the drawing. The transmission device 1 is configured so as to realize functions of the present exemplary embodiment by making CPU execute a program which spreads in the main storage device. Here, the program used in the present exemplary embodiment may be stored by the auxiliary storage device, or may be acquired from an external storage device which is accessible through the communication circuit network 3.

For example, the transmission device 1 can be configured as an information processing device such as a general computer, a general server device or the like. Here, the transmission device 1 may be configured as a transmission terminal which transmits data to a mobile terminal such as a cellular phone, a smartphone or the like, a car navigation terminal, a game terminal or the like.

(Reception Device)

The reception device 2 is realized as an information processing device which has a general hardware configuration including CPU, a main storage device, an auxiliary storage device, a communication device, and the like that are not shown in the drawing. Moreover, the reception device 2 has an output device, which displays received data, such as a screen or the like, and an input device, which is used for inputting data, such as a key board, a mouse or the like. The reception device 2 can carry out various applications by making CPU execute a program which spreads in the main storage device.

For example, the reception device 2 can be configured as a computer of a desktop type, a note type, a tablet type or the like. The reception device 2 may be configured as a reception terminal such as a mobile terminal like a cellular phone, a smartphone or the like, a car navigation terminal, a game terminal or the like.

Hereinafter, a functional configuration, an operation, an effect, and the like of the transmission device according to the exemplary embodiment of the present invention will be explained with reference to drawings.

(Configuration)

Firstly, the transmission device 1 according to the first exemplary embodiment of the present invention will be explained in detail.

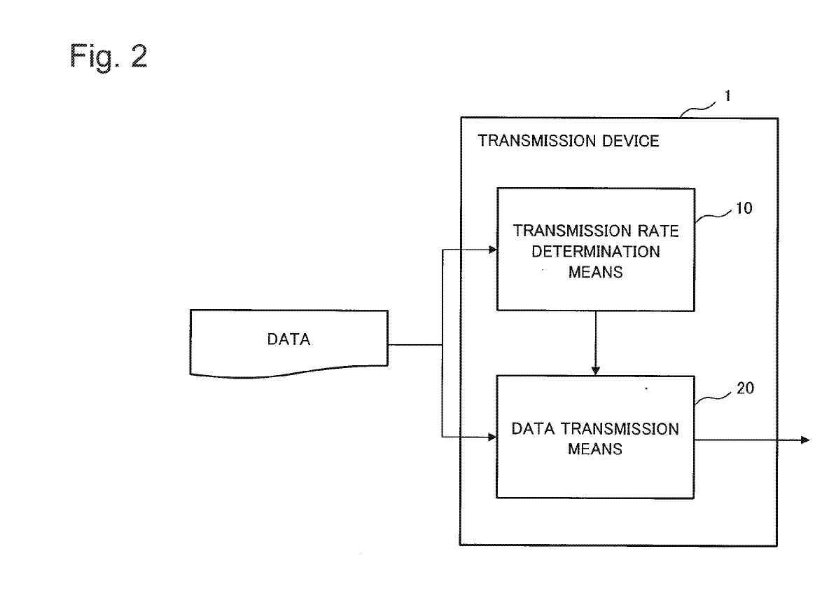

FIG. 2 is a block diagram showing the functional configuration of the transmission device 1 according to the present exemplary embodiment. The transmission device 1 according to the present exemplary embodiment includes a transmission rate determination means 10 and a data transmission means 20.

[Transmission Rate Determination Means]

When a certain frame data is generated, the transmission rate determination means 10 determines the transmission rate (a size of data to be transmitted per a unit time) which is used at a time when transmitting the frame data. Hereinafter, the data size of the frame data is denoted as S, and a time when the frame data is generated is denoted as t=0. At this time, to find out the optimum transmission rate u*(t), which makes a delay time short and makes a loss small, from the unknown function u(t) is a role of the transmission rate determination means 10. Moreover, the transmission rate which is set firstly to the generated frame data is called the initial transmission rate.

The transmission rate determination means 10 uses the unknown function with respect to the time t as the initial transmission rate u(t). Here, if the frame data are transmitted periodically, the optimum transmission rate U(t), which has been calculated already, may be used as the initial transmission rate u(t). Hereinafter, the initial transmission rate u(t) is merely denoted as a transmission rate u(t).

Here, a functional configuration of the transmission rate determination means 10 will be explained in detail with reference to the drawings.

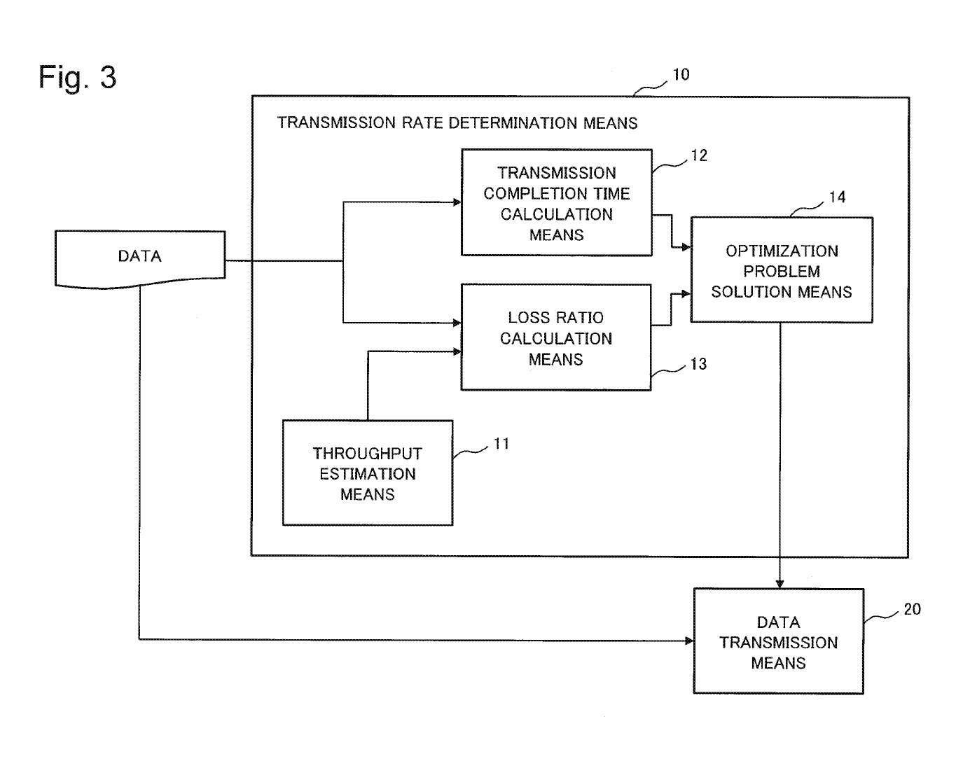

FIG. 3 is a block diagram showing the functional configuration of the transmission rate determination means 10 according to the present exemplary embodiment. The transmission rate determination means 10 according to the present exemplary embodiment includes a throughput estimation means 11, a transmission completion time calculation means 12, a loss ratio calculation means 13 and an optimization problem solution means 14.

[Throughput Estimation Means]

The throughput estimation means 11 estimates the throughput which is generated when the transmission device 1 transmits the data to the reception device 2 through the communication circuit network 3. Here, the throughput means the data size of data which can reach per a unit time from the transmission device 1 to the reception device 2 with no loss.

For example, it is assumed that the transmission device 1 transmits 10 Mbyte data per a second (unit time), and 2 Mbyte data out of 10 Mbyte data are lost in the communication circuit network 3, and left 8 Mbyte data are received by the reception device 2. In this case, it is found out that the transmission rate is 10 Mbyte/sec, and the throughput is 8 Mbyte/sec. In other words, the throughput means an amount of data which can pass through the communication circuit network 3.

Actually, the transmission rate is not fixed. That is, the transmission rate can be described as a time-variant function u(t). A role of the throughput estimation means 11 is to estimate the throughput ν(t) on the condition that the transmission rate u(t) is given.

For example, PCT/JP2009/282617 (related literature) discloses that, in the case of considering a system whose input is the transmission rate u(t), and whose output is the throughput ν(t), the system is corresponding to the dynamical system (dynamics model). Moreover, the related literature discloses that it is possible to construct a precise model of the dynamical system by use of a viscoelastic body. Here, the viscoelastic body is a substance, which has viscosity and elasticity, such as rubber or the like

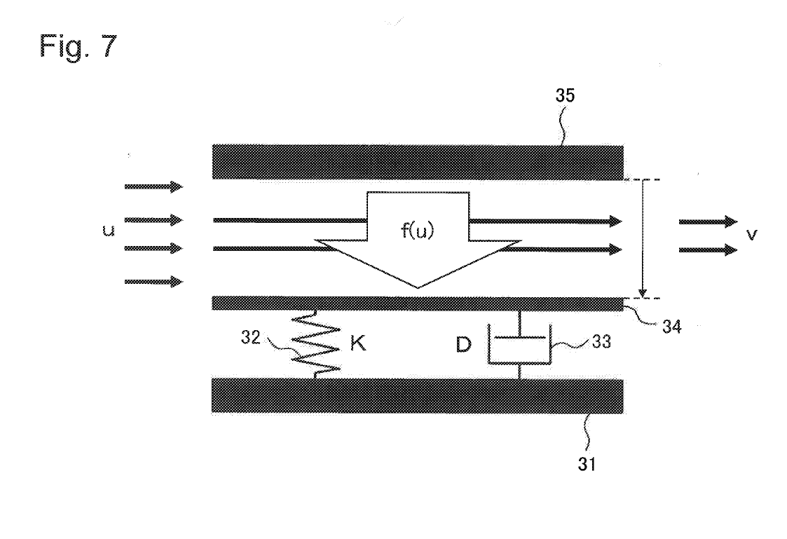

Next, the dynamical system will be explained with reference to FIG. 7. In the present exemplary embodiment, the dynamical system using the viscoelastic body model is applied.

FIG. 7 is a schematic diagram describing a relation between the transmission rate and the throughput ν(t), which is generated when transmitting the data into the communication circuit network 3 at a certain transmission rate u(t), by use of the viscoelastic body model.

According to the viscoelastic body model shown in FIG. 7, a spring 32 (elastic element) and a damper 33 (viscid element) are arranged on a floor 31 (first fixed part) to support a board 34 (movable part). It is supposed that a distance ν(t) from a ceiling 35 (second fixed part) to the board 34 (movable part) is corresponding to a passable amount of data, that is, the throughput.

Moreover, it is assumed that force, whose magnitude is a value of function ƒ(u) including the inputted transmission rate u(t) as a variable, pushes the board (movable part) downward. The board 34 (movable part) moves upward and downward due to the force f(u), and force generated by the spring 32 (elastic element) and the damper 33 (viscid element). Here, it is assumed that, when f is equal to 0, the distance ν from the ceiling (second fixed part) is equal to 0, and then the board 34 (movable part) is in a balanced state (stationary state).

Taking the above-mentioned viscoelastic body model into consideration, the relation between the transmission rate u(t) and the throughput ν(t) can be expressed by the following differential equation Formula 1 as a linear differential equation model. Here, D is a coefficient of viscosity, and K is a coefficient of elasticity in Formula 1.

$$D \frac{d v}{d t} + Kv = f ( u ) \qquad ( 1 )$$

The throughput estimation means 11 can estimate the throughput ν(t) for any u(t) by solving the differential equation which is expressed by Formula 1 In the case that the coefficient of viscosity D is a constant which is not equal to 0, and the coefficient of elasticity K is a constant, a general solution of Formula 1 is given by Formula 2. The general solution ν(t) shown in Formula 2 is an estimated value of the throughput.

$$v ( t ) = {e}^{\frac{K}{D} t} {\int }_{0}^{t} {e}^{\frac{K}{D} τ} \frac{f ( u ( τ ) )}{D} d τ \qquad ( 2 )$$

However, it is necessary to estimate the coefficient of viscosity D and the coefficient of elasticity K in advance. Specifically, the transmission device 1 actually transmits the data at an appropriate transmission rate u(t), and the reception device 2 actually measures the throughput ν(t). Then, by applying, for example, the minimum square estimation method, it is possible to estimate the coefficient of viscosity D and the coefficient of elasticity K on the basis of u(t) and ν(t).

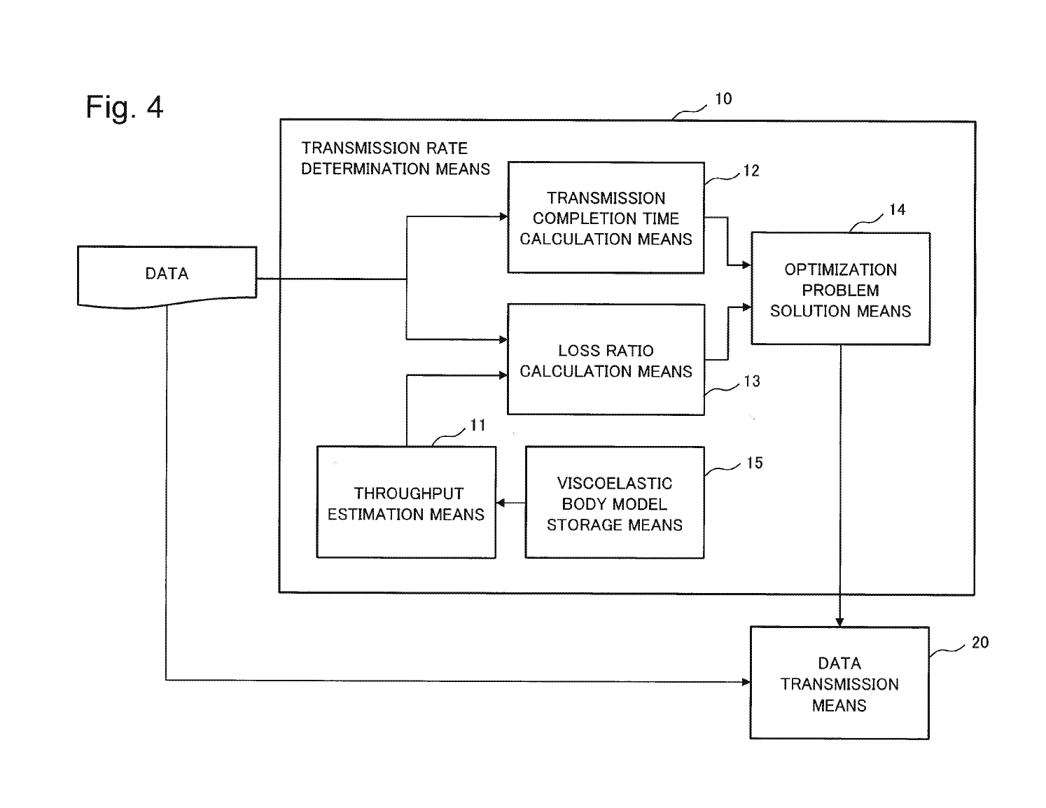

The coefficient of viscosity D and the coefficient of elasticity K, which are estimated, can be stored by a viscoelastic body model storage means 15 shown, for example, in a modification of FIG. 4. The viscoelastic body model storage means 15 may be assigned, for example, in an area of the main storage device, or may be assigned to registers of CPU not shown in the drawing. Moreover, in the case that CPU realizes the throughput estimation means 11, the registers of CPU, which realizes the throughput estimation means 11, may store the coefficient of viscosity D and the coefficient of elasticity K.

While the Kelvin-Voigt model including one elastic element and one viscid element, which are arranged in parallel, is exemplified as the viscoelastic body model in the above explanation, a different viscoelastic body model such as the standard linear solid model or the like may be used. Moreover, a viscoelastic body model which includes any combination of the plural elastic elements and the plural viscid elements.

That is, in the case that a certain transmission rate u(t) is given, the throughput estimation means 11 solves the differential equation expressed by Formula 1 by use of the coefficient of viscosity D and the coefficient of elasticity K, which are estimated in advance, to estimate the throughput ν(t) expressed by Formula 2.

Then, the throughput estimation means 11 outputs the estimated value of the throughput to the loss ratio calculation means 13.

[Transmission Completion Time Calculation Means]

The transmission completion time calculation means 12 calculates a time T which, in the case of transmitting frame data whose data size is S at the transmission rate u(t), is taken until transmission of the frame data is completed.

Since a total amount of transmission data is S when transmitting the data from a time t=0 up to a time t=T at the transmission rate u(t), the following Formula 3 is satisfied.

∫₀^{T}u(t)dt=S (3)

Here, on the condition that u(t) is positive and finite in the case of t≧0, a primitive function U(t) of u(t) which is expressed by Formula 4 exists.

U(t)=∫₀^{t}u(τ)dτ (4)

Since U(t) is a continuous function and a narrow-sense monotonically increasing function in the case of t≧0, an inverse function exists at a section [0, supU], and consequently the transmission completion time T is expressed by Formula 5.

T=U⁻¹(S) (5)

That is, by solving Formula 5, the transmission completion time calculation means 12 calculates the transmission completion time T of the frame data whose data size is S. Here, the transmission completion time T which is calculated by the transmission completion time calculation means 12 is a functional whose argument is the unknown function u(t).

Then, the transmission completion time calculation means 12 outputs the calculated transmission completion time T.

[Loss Ratio Calculation Means]

In the case of transmitting frame data whose data size is S at the transmission rate u(t), the loss ratio calculation means 13 calculates a loss ratio L (0≦L≦1) which is a ratio of the frame data lost in the communication circuit network 3 to all of the transmitted frame data.

An amount of the lost frame data is denoted as S_{L}. Since S_{L} causes a shortage of the throughput in comparison with the transmission rate, S_{L} can be calculated by Formula 6.

S_{L}=∫₀^{T}(u(t)−ν(t))dt=S−∫₀^{T}ν(t)dt (6)

Here, since ν(t) which is on the right side of Formula 6 is calculated by Formula 2, by replacing ν(t) of formula 6 with ν(t) calculated by Formula 2, the loss ratio L can be calculated by the following Formula 7.

$$L = \frac{{S}_{L}}{S} = 1 - \frac{1}{S} {\int }_{0}^{T} ( {e}^{- \frac{K}{D} t} {\int }_{0}^{t} {e}^{\frac{K}{D} τ} \frac{f ( u ( τ ) )}{D} d τ ) d t \qquad ( 7 )$$

That is, by solving Formula 7, which is acquired by replacing ν(t) of Formula 6 with the estimated throughput value ν(t) acquired from the throughput estimation means 11, the loss ratio calculation means 13 calculates the loss ratio L of the frame data whose data size is S. Here, the loss ratio L which is calculated by the loss ratio calculation means 13 is a functional whose argument is the unknown function u(t).

Then, the loss ratio calculation means 13 outputs the calculated loss ratio L.

[Optimization Problem Solution Means]

The optimization problem solution means 14 determines the optimum transmission rate u*(t) on the basis of the transmission completion time T which the transmission completion time calculation means 12 calculates by use of Formula 5, and the loss ratio L which the loss ratio calculation means 13 calculates by use of Formula 7.

By the way, an object of the exemplary embodiment of the present invention is to realize frame data transmission with ‘a short delay time and a small amount of loss’. That is, the object is to find a condition ‘which makes the transmission completion time T short, and makes the loss ratio L small’.

However, a relation between to make the transmission completion time T short and to make the loss ratio L small is the relation of trade-off. Accordingly, it is impossible to make each of the transmission completion time T and the loss ratio L small independently. That is, it is necessary to define some index in order to asses a degree of approach to the object of ‘the short delay time and the small loss’.

In the present exemplary embodiment, a cost function which is composed of the calculated transmission completion time T and the calculated loss ratio L is defined. Then, the transmission rate u*(t) which makes the cost function minimum is regarded as the optimum transmission rate.

That is, the optimization problem solution means 14 solves the optimization problem existing between the transmission completion time T and the loss ratio, which are in the trade-off relation, by use of the cost function including the transmission completion time T and the loss ratio L. Here, the specific cost function which is defined by the optimization problem solution means 14 will be explained later. It is pointed out here that it is mandatory that the cost function used in the present exemplary embodiment is a monotonically not-decreasing function.

Then, the optimization problem solution means 14 outputs the acquired optimum transmission rate u*(t). The optimum transmission rate u*(t) which is acquired by the optimization problem solution means 14 is inputted into the data transmission means 20.

Here, the throughput estimation means 11 and the transmission completion time calculation means 12 may be configured so as to be able to refer to the optimum transmission rate u*(t).

[Data Transmission Means]

The data transmission means 20 inputs the optimum transmission rate u*(t) which is acquired and outputted by the transmission rate determination means 10, and transmits the frame data at the optimum transmission rate u*(t).

The above is explanation on the transmission and reception system which includes the transmission device 1 according to the exemplary embodiment of the present invention.

(Relation Between Components)

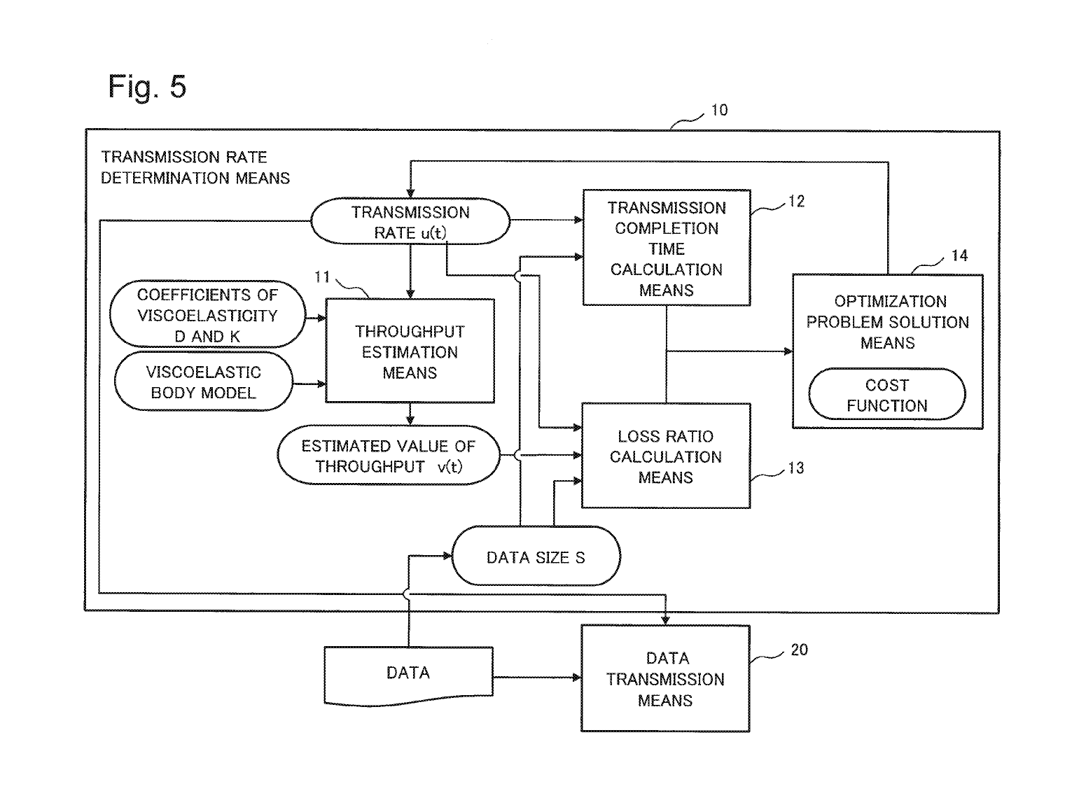

An organic coupling relation between components of the transmission device 1 will be explained in the following with reference to a drawing. FIG. 5 is a conceptual diagram which organically shows the coupling relation between the components of the transmission rate determination means 10 shown in FIG. 3

The throughput estimation means 11 estimates the throughput ν(t) by use of the transmission rate u(t). In the present exemplary embodiment, the throughput estimation means 11 applies the coefficient of viscosity D and the coefficient of elasticity K to the viscoelastic body model to estimate the throughput ν(t). The throughput estimation means 11 outputs the estimated throughput ν(t).

The transmission completion time calculation means 12 calculates the transmission completion time T by use of the data size S of the frame data to be transmitted, and the transmission rate u(t). The transmission completion time calculation means 12 outputs the calculated transmission completion time T to the optimization problem solution means 14.

The loss ratio calculation means 13 calculates the loss ratio L by use of the throughput ν(t) which is estimated by the throughput estimation means 11, the data size S of the frame data to be transmitted, and the transmission rate u(t). The loss ratio calculation means 13 outputs the calculated loss ratio L to the optimization problem solution means 14.

The optimization problem solution means 14 defines the cost function by use of the transmission completion time T which is calculated by the transmission completion time calculation means 12, and the loss ratio L which is calculated by the loss ratio calculation means 13, and outputs the transmission rate u*(t), which makes the value of the cost function minimum, as the optimum transmission rate.

Here, the optimum transmission rate u*(t) which is outputted by the optimization problem solution means 14 may be set as a new transmission rate u(t). In this case, it is a preferable configuration that the data transmission means 20 inputs the new transmission rate u(t), and furthermore the throughput estimation means 11 and the transmission completion time calculation means 12 refer to the new transmission rate u(t).

Then, the data transmission means 20 transmits the frame data at the optimum transmission rate u*(t).

The above is explanation on the organic coupling relation between the components of the transmission device 1.

(Operation)

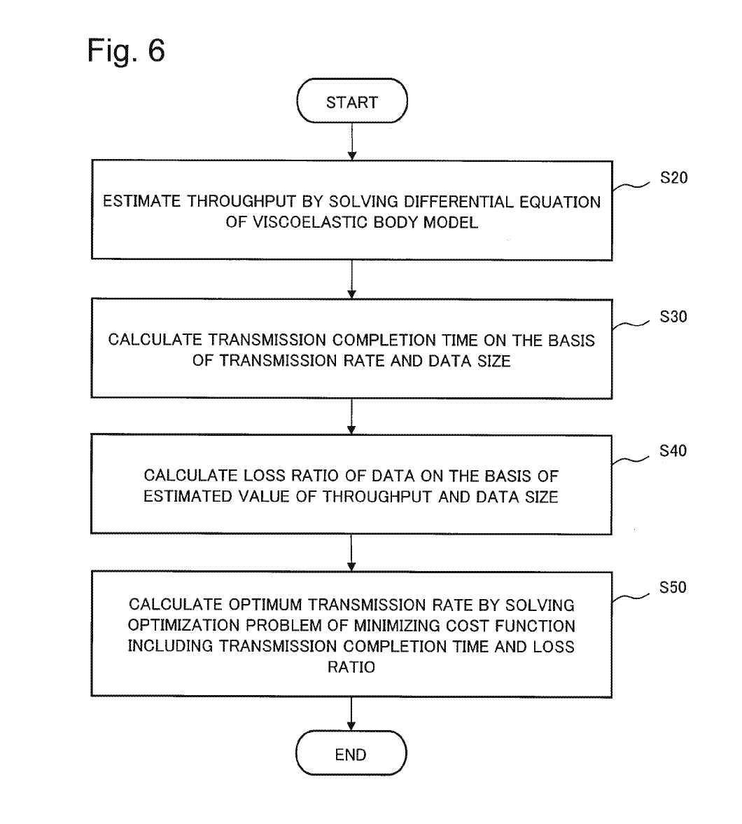

Next, an operation of the transmission rate determination means 10 of the transmission device 1 according to the first exemplary embodiment will be explained with reference to the flowchart shown in FIG. 6. Here, detailed function of each component is omitted.

The throughput estimation means 11 solves the differential equation of the viscoelastic body model by use of the transmission rate u(t), which is the unknown function, to estimate the throughput ν(t) of the frame data Step 20.

The transmission completion time calculation means 12 calculates the transmission completion time T of the frame data on the basis of the transmission rate u(t) and the data size S of the frame data (Step S30).

The loss ratio calculation means 13 calculates the loss ratio L of the frame data on the basis of the throughput ν(t) and the data size S of the frame data which are estimated (Step S40).

While FIG. 6 shows that calculation of the transmission completion time T (Step S30), and calculation of the loss ratio L (Step S40) are carried out in series, the calculations may be carried in parallel.

The optimization problem solution means 14 defines the cost function by use of the transmission completion time T and the loss ratio L, and acquires the optimum transmission rate u*(t), which makes the defined cost function minimum, as the specific function (Step S50).

The above is explanation on the operation of the transmission rate determination means 10 according to the present exemplary embodiment.

Here, by setting the acquired optimum transmission rate again so as to be the initial transmission rate and repeating the above-mentioned procedure, it is also possible to dynamically control the transmission rate.

(Effect)

According to the transmission device of the exemplary embodiment of the present invention, it is possible to realize the data transmission with the short delay time and the small data loss. As a result, it is possible to provide the bit rate control which can enhance both of the responsiveness and the media quality.

The technique according to the exemplary embodiment of the present invention is suitable for a case that a large amount of data (data including a plurality of packets) are generated periodically, and are transferred in real time by UDP (User Datagram Protocol). For example, the technique according to the exemplary embodiment of the present invention is suitable for media data or stream data. Here, the media data is corresponding to a superordinate concept of the frame data, and the stream data includes sensor data other than an image and a voice.

(Cost Function)

Next, a cost function J according to the present exemplary embodiment will be explained by use of Formula 8.

J=(1−λ)T+λL (8)

In formula 8, λ, which is a constant (0≦λ<1), is used as a weight for making the transmission completion time T short and making the loss ratio L small.

By replacing the transmission completion time T and the loss ratio L of Formula 8 with the transmission completion time T which is calculated by use of Formula 5, and the loss ratio L which is calculated by use of Formula 7 respectively, the cost function J can be expressed by Formula 9.

$$J = ( 1 - λ ) {U}^{- 1} ( S ) + λ [ 1 - \frac{1}{SD} {\int }_{0}^{T} ( {e}^{\frac{K}{D} t} {\int }_{0}^{t} {e}^{\frac{K}{D} τ} f ( u ( τ ) ) d τ ) d t ] \qquad ( 9 )$$

In Formula 9, the cost function J is a function of the unknown function u(t), that is, J is a functional. That is, by finding out u(t), which makes the cost function J minimum, as the specific function u*(t), the object of the exemplary embodiment of the present invention can be achieved.

However, the cost function J is a complicated functional which includes an integral of the transmission rate u(t), and an inverse function of the primitive function. Therefore, it is quite difficult to find out the transmission rate u(t), which makes the cost function J of Formula 9 minimum, out of any function space. Then, practically, by limiting solution space of u(t), it is possible to find out the specific function u(t). Here, the solution space is the function space from which u(t) is found out. Moreover, ‘to limit the solution space’ means that a target function is limited to, for example, only a linear function.

Hereinafter, a solution method on the condition that u(t) is limited to a ramp function will be specifically explained. The ramp function is a function which increases in a linear form from a time t=0, and is expressed by Formula 10, where a (a>0) is a constant which indicates an inclination of the ramp function.

$$u ( t ) = \{ \begin{matrix}at & ( t > 0 ) \\ 0 & ( t \leq 0 )\end{matrix} \qquad ( 10 )$$

Steep increase of the transmission rate in a form of a general step function makes a loss, which is due to the viscid element of the viscoelastic body model, increasing. Therefore, in the present exemplary embodiment, the ramp function, which restrains the loss by gradually increasing the transmission rate, is exemplified.

When replacing u(t) of the throughput estimation formula (Formula 2), which the throughput estimation means 11 estimates, with u(t) of Formula 10, a throughput estimation formula of Formula 11 is acquired. For simplification, f(u) is defined as u in Formula 11.

$$v ( t ) = \frac{a}{K} t - \frac{aD}{{K}^{2}} ( 1 - {e}^{\frac{K}{D} t} ) \qquad ( 11 )$$

The data size S is found out by replacing u(t) of Formula 3 with u(t) of Formula 10. Then, by replacing S of Formula 5 with the data size S which is found out, it is found out that the transmission completion time T is expressed by Formula 12.

$$T = \sqrt{\frac{2 S}{a}} \qquad ( 12 )$$

By replacing u(t) and ν(t) of Formula 7 with u(t) of Formula 10 and ν(t) of Formula 11 respectively, it is found out that the loss rate L is expressed by Formula 13.

$$L = 1 - \frac{1}{S} \{ \frac{{aT}^{ 2}}{2 K} - \frac{aDT}{{K}^{2}} + \frac{{aD}^{2}}{{K}^{3}} ( 1 - {e}^{- \frac{K}{D} t} ) \} \qquad ( 13 )$$

Accordingly, by replacing L of Formula 8 with L of Formula 13, it is found out that the cost function J is expressed by Formula 14.

$$J = ( 1 - λ ) T + λ - \frac{λ}{S} \{ \frac{{aT}^{ 2}}{2 K} - \frac{aDT}{{K}^{2}} + \frac{{aD}^{2}}{{K}^{3}} ( 1 - {e}^{- \frac{K}{D} t} ) \} \qquad ( 14 )$$

While Formula 9 is the complicated functional, by limiting u(t) to the ramp function, the cost function can be simplified to be expressed by an elementary function (Formula 14) with respect to an inclination a. Since the cost function is expressed by Formula 14, it is possible to find out a which makes the cost function J minimum.

Since the cost function J of Formula 14 is differentiable and convex in a downward direction with respect to a, a to be found out is corresponding to a zero point of dJ/da, that is, a to be found out satisfies dJ/da=0. Accordingly, the cost function is differentiated with respect to a as shown in Formula 15.

$$\frac{d J}{d a} = ( 1 - λ ) \frac{d T}{d a} - \frac{λ}{S} \{ \frac{{T}^{2}}{2 K} + \frac{aT}{K} \frac{d T}{d a} - \frac{DT}{{K}^{2}} - \frac{aD}{{K}^{2}} \frac{d T}{d a} + \frac{{D}^{2}}{{K}^{3}} ( 1 - {e}^{\frac{K}{D} t} ) + \frac{aD}{{K}^{2}} {e}^{\frac{K}{D} t} \frac{d T}{d a} \} \qquad ( 15 )$$

Here, dT/da in Formula 15 is given by Formula 16.

$$\frac{d T}{d a} = - \sqrt{\frac{S}{2 {a}^{3}}} \qquad ( 16 )$$

A zero point of dJ/da expressed by Formula 15 can be easily found out by the numerical analysis method such as the Newton method or the like.

An example of finding out the optimum transmission rate, that is, finding out the optimum a on the condition that K=1.01, D=0.01, S=0.1 Mbit and λ=0.95, which are parameters of a specific numerical example, will be shown in the following.

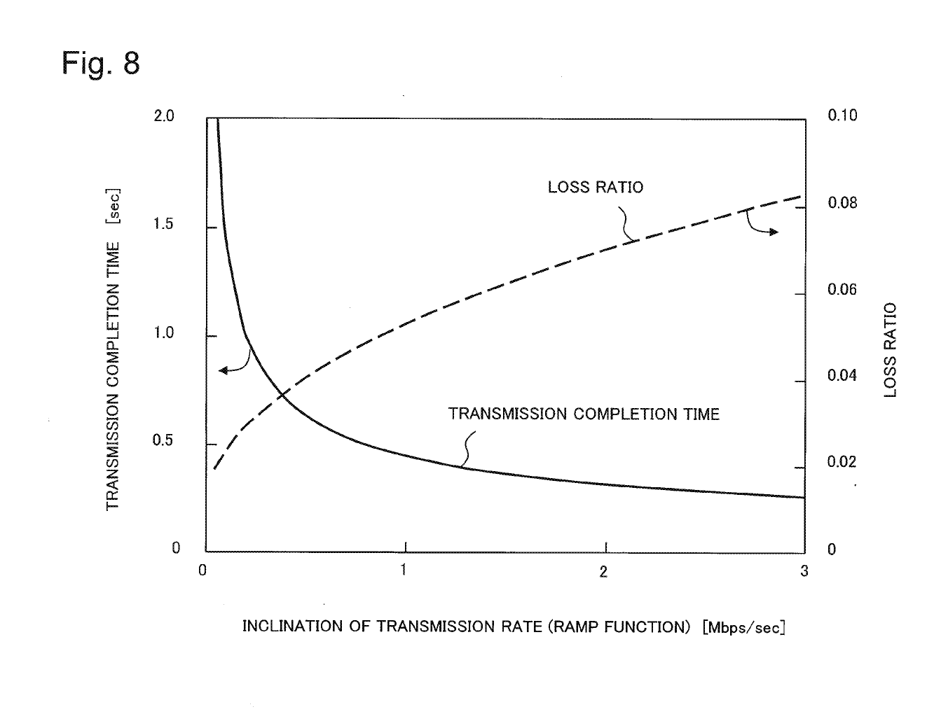

FIG. 8 is a graph showing the transmission completion time T and the loss ratio L according to the specific numerical example. The horizontal axis indicates a, and the vertical axis indicates the transmission completion time T (left side vertical axis) and the loss ratio L (right side vertical axis).

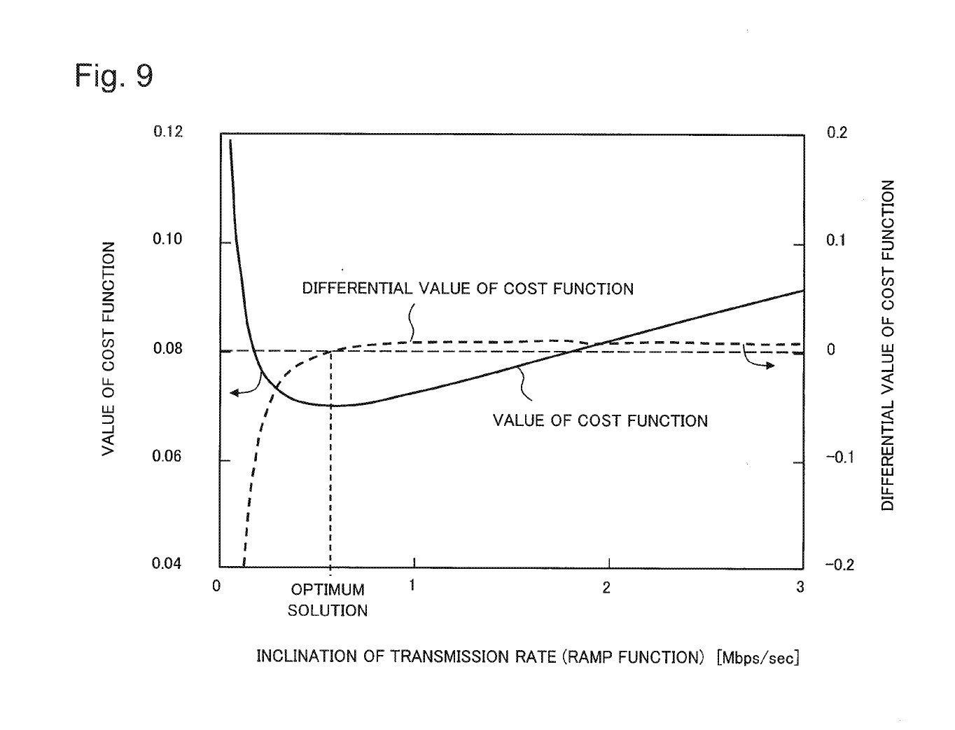

FIG. 9 shows the cost function J and the differential value dJ/da of the cost function J according to the specific numerical example. The zero point of dJ/da (point at which dJ/da=0) is the minimum point of the cost function J, and a which is corresponding to the zero point is the optimum solution. In FIG. 9, the optimum solution is a=0.56 Mbps/sec

That is, it is found out that a measure for solving the optimization problem in the above-mentioned numerical example is to increase the transmission rate in a form of ramp function whose coefficient a is 0.56 Mbps/sec. In this case, the transmission completion time T is 0.6 sec, and the loss ratio L is 0.07.

While the cost function according to the example of Formula 8 is a linear combination of the transmission completion time T and the loss ratio L, for example, a cost function of a quadratic form expressed by Formula 17 may be used.

J=(1−λ)T²+λL² (17)

In the present exemplary embodiment, it is possible to use not only the cost functions expressed by Formula 8 and Formula 17 but also any cost function including the transmission completion time T and the loss ratio L. Here, it is desirable that the cost function used in the exemplary embodiment is monotonically not-decreasing with respect to the transmission completion time T and the loss ratio L.

For example, the transmission rate determination means of the transmission device according to the exemplary embodiment of the present invention may be configured so as to be a transmission rate determination device which is separated from the transmission device.

While it has been described that each function in the above-mentioned exemplary embodiment is realized by CPU's executing the program (software), each function may be realized by hardware such as a circuit or the like.

Moreover, the program of the above-mentioned exemplary embodiment may be stored by a computer-readable program storage medium. For example, a magnetic disc, a magneto-optical disc, or a movable medium such as a semiconductor memory or the like can be used as the program storage medium.

### INDUSTRIAL APPLICABILITY

The present invention is applicable to a frame data transmission device. It is preferable to apply the present invention, for example, to distribution of the voice and the image, which do not receive any influence if an amount of lost data is slight, and an on-line game which transfers a plenty of clusters of small data in real time.

Hereinbefore, by exemplifying the above-mentioned exemplary embodiments as the preferable example, the present invention is explained. However, the present invention is not limited to the above-mentioned exemplary embodiments. That is, the present invention can apply various aspects, which a person skilled in the art can understand, within the scope of the present invention.

This application is based upon and claims the benefit of priority from Japanese Patent Application No. 2014-007780, filed on Jan. 20, 2014, the disclosure of which is incorporated herein in its entirety by reference.

### REFERENCE SIGNS LIST

1 transmission device
2 reception device
3 communication circuit network
10 transmission rate determination means
11 throughput estimation means
12 transmission completion time calculation means
13 loss ratio calculation means
14 optimization problem solution means
15 viscoelastic body model storage means
20 data transmission means
31 floor
32 spring
33 damper
34 board
35 ceiling

1. A transmission device for transmitting data to a reception device through a communication circuit network, the transmission device comprising:
a transmission rate determination circuitry that calculates an optimum transmission rate by estimating a throughput generated when the data is transmitted to the reception device at an initial transmission rate set as an unknown function, calculates a transmission completion time, which is taken until transmission of the data to the reception device is completed, by use of a data size of the data and the initial transmission rate, and calculates a loss ratio of the data in the communication circuit network on the basis of the throughput, the data size, and the initial transmission rate, and solving an optimization problem of minimizing a cost function including the transmission completion time and the loss ratio; and
a data transmission circuitry that transmits the data at the optimum transmission rate.

2. The transmission device according to claim 1, wherein
on the basis of a model parameter of a dynamics model, the transmission rate determination circuitry estimates the throughput by defining an input and an output of the dynamics model as the transmission rate and the throughput respectively.

3. The transmission device according to claim 2, wherein
the transmission rate determination circuitry uses a viscoelastic body model, which includes a viscid element and an elastic element, as the dynamics model.

4. The transmission device according to claim 1, wherein
the transmission rate determination circuitry uses a function, which includes the transmission completion time and the loss ratio and which is monotonically not-decreasing with respect to the transmission completion time and the loss ratio, as the cost function.

5. The transmission device according to claim 1, wherein
the transmission rate determination circuitry calculates the optimum transmission rate by limiting solution space of the initial transmission rate.

6. The transmission device according to claim 1, wherein
the transmission rate determination circuitry, comprising:
a throughput estimation circuitry that estimates the throughput which is generated when the data is transmitted to the reception device at the initial transmission rate;
a transmission completion time calculation circuitry that calculates the transmission completion time, which is taken until transmission of the data to the reception device is completed, by use of the data size of the data and the initial transmission rate;
a loss ratio calculation circuitry that calculates the loss ratio of the data in the communication circuit network on the basis of the throughput, the data size, and the initial transmission rate; and
an optimization problem solution circuitry that calculates the optimum transmission rate by solving the optimization problem of minimizing the cost function including the transmission completion time and the loss ratio.

7. The transmission device according to claim 6, wherein
in a dynamics model which includes a first fixed part, the elastic element and the viscid element which are arranged on one surface of the first fixed part, a movable part which is supported by the elastic element and the viscid element, and a second fixed part which is opposite to the movable part, the throughput estimation circuitry defines an input into an opening, which is arranged between the second fixed part and the movable part, as the transmission rate, and defines a distance between the second fixed part and the movable part, which is generated when force whose magnitude is given by a function including the transmission rate as a variable is applied to the movable part, as the throughput, and wherein
the throughput estimation circuitry estimates the throughput by solving the following differential equation.
$$D \frac{d v}{d t} + Kv = f ( u )$$
where:
D is a coefficient of viscosity;
K is a coefficient of elasticity;
u is the transmission rate;
ν is the throughput;
f(u) is the force which is applied to the movable part in the case of the transmission rate u; and
t is a time.

8. The transmission device according to claim 6, wherein
the optimization problem solution circuitry uses the following formula as the cost function.
J(1−λ)T+λL
where:
J is the cost function;
λ is a constant (0≦λ<1);
T is the transmission completion time; and
L is the loss ratio.

9. A transmission method for transmitting data to a reception device through a communication circuit network, the transmission method comprising:
calculating an optimum transmission rate by estimating a throughput which is generated when the data is transmitted to the reception device at an initial transmission rate set as an unknown function,
calculating a transmission completion time, which is taken until transmission of the data to the reception device is completed, by use of a data size of the data and the initial transmission rate,
calculating a loss ratio of the data in the communication circuit network on the basis of the throughput, the data size, and the initial transmission rate, and solving an optimization problem of minimizing a cost function including the transmission completion time and the loss ratio; and
transmitting the data at the optimum transmission rate.

10. A program recording medium for storing a transmission program that transmits data to a reception device through a communication circuit network, the transmission program causing a computer to execute:
a process for estimating a throughput which is generated when the data is transmitted to the reception device at an initial transmission rate set as an unknown function;
a process for calculating a transmission completion time, which is taken until transmission of the data to the reception device is completed, by use of a data size of the data and the initial transmission rate;
a process for calculating a loss ratio of the data in the communication circuit network on the basis of the throughput, the data size, and the initial transmission rate;
a process for calculating an optimum transmission rate by solving an optimization problem of minimizing a cost function including the transmission completion time and the loss ratio; and
a process for transmitting the data at the optimum transmission rate.
